(19) United States
(12) Patent Application Publication
(10) Pub. No.: US 2008/0100568 A1
(43) Pub. Date: May 1, 2008

(54) Electronic device providing tactile feedback

(76) Inventors: Paul B. Koch, Plantation, FL (US); Steve X. Dai, Gilbert, AZ (US); Manuel Oliver, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/590,494

(22) Filed: Oct. 30, 2006

(51) Int. Cl. G09G 5/00

(52) U.S. Cl. 345/156

(57) ABSTRACT

An electronic device (100) provides tactile feedback provided by a low cost, thin piezoelectric actuator (142) giving tactile feedback emulating a click like feed. The electronic device (100) comprises a chassis plate (122) having a periphery secured to a housing (102, 104) and comprising a flexible material having a first planer side (123), and a second planer side (125) opposed to the first planer side (123). An input device (110) has a planer side (111) positioned adjacent to and in contact with to the first planer side (123) of the chassis (122) and extends through an opening (108) in the housing (102, 104). One or more piezoelectric actuators (142) are secured to the second planer side (125) and within the periphery of the chassis plate (122). Electronic circuitry (208) positioned within the housing (102, 104) drives the piezoelectric actuators (142) in response to the input device (110) being actuated. The input provided to the input device (110) is sensed by the electronic circuitry (208). The circuitry (208) provides a voltage waveform to activate the one or more piezoelectric actuators (142), which flexes the chassis plate (122) and the input device (110) to emulate the click like feed. A second exemplary embodiment positions the piezoelectric actuators (142) between the chassis plate (122) and the input device (110).

### FIELD OF THE INVENTION

The present invention generally relates to electronic devices and more particularly to a portable communication device having tactile feedback.

### BACKGROUND OF THE INVENTION

Morphable user interfaces are expected to be an important design consideration for the next generation of portable electronic devices. A morphable user interface is one that changes its appearance as the use of the device, e.g. phone, camera, music player, changes. Users will find the input interface simpler and more intuitive to use. However, the conventional means of providing tactile feedback when pressing a key, to a finger, for example, has been mechanical dome switches. Dome switches will not function well with morphable graphic user interfaces; therefore, haptics or active feedback becomes a critical enabler. While DC rotary or linear vibration motors could provide tactile feedback to a finger input with an optimized driving algorithm, the buzz-like vibration profile is very different from a dome switch that generates a sharp mechanical click at the user's finger.

Localized haptics sends tactile feedback to a user through movement of a portion of a handheld device. Locally actuated touch screen and navigation keys are two examples of localized haptics. In the case of a cell phone, the feedback could be limited to a navigation key, a touch screen or buttons on holding surfaces of the phone, e.g., side stripes. There are two distinct tactile feedbacks in a cell phone. One is a vibrotactile feedback, a vibration pattern generated by a vibration motor to a user's hand or finger. Conventional vibrating call alert is a good example. The other is a click a user typically feels on a keypad when entering numbers or letters. The click is realized by actuating one of the passive metal dome switches placed beneath a keypad.

One type of haptic feedback may be found, for example in U.S. Pat. No. 6,710,518. An electromechanical transducer produces an impulse of mechanical energy that propagates through a mounting boss to the entire device. This mechanism is great for providing a “call alert” for example, but does not allow for selective feedback to individual input locations (keys, buttons, arrows, etc).

Another type of haptic feedback is found, for example in U.S. Patent Publications 2006/0050059 and 2006/0052143. One or several piezoelectric actuators are placed, typically at the corners, under an input device that needs to be actuated. The input device could be a keypad or a display with touch sensitive surface. Upon application of electric voltage, the piezoelectric actuators deform, either pushing or pulling the entire input device in a given direction and thus give a tactile feedback to the users' hand or finger operating at the input device. The most widely used piezoelectric actuators for this purpose are typically unimorph actuators, which are made of a piezoelectric ceramic element bonded to a metal shim, or bimorph actuators, which are made of metal shim bonded in between of two piezoelectric ceramics elements. Both unimorph and/or bimorph actuators are also referred to as benders. In a unimorph actuator, the bending motion comes from the tendency of either in-plane shrinkage or expansion of the piezoelectric ceramic element under applied electric field against the mechanical constraint from the metal shim. In the case of a bimorph actuator, the two piezoelectric ceramic elements are driven such that one shrinks while the other expand, causing the bending motion. A typical placement of the benders is to anchor the edge of a circular bender, or both ends of a stripe bender, on a base structure. The center of a circular bender, or the middle of a stripe bender which has the maximum displacement, is usually used to drive a mechanical load, as illustrate in both U.S. Patent Publications 2006/0050059 and 2006/0052143. It is note worthy that the relatively high displacement from bending motion of a unimorph actuator or a bimorph actuator is only possible from the bonded structure of piezoelectric ceramic element(s) and metal shim. A stand alone piezoelectric ceramic could not generate such displacement.

Accordingly, it is desirable to provide an electronic device having tactile feedback provided by a low cost, thin piezoelectric device giving tactile feedback emulating a click like feed. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

An electronic device provides tactile feedback provided by a low cost, thin piezoelectric device giving tactile feedback emulating a click-like feel. The apparatus comprises a chassis plate having a periphery secured to a housing and comprises a flexible material having a first planar side, and a second planar side opposed to the first planar side. An input device has a planar side positioned adjacent to and in contact with to the first planar side of the chassis. One or more piezoelectric actuators are secured to the second planar side and within the periphery of the chassis plate. Electronic circuitry positioned within the housing drives the piezoelectric actuator in response to a user actuating the input device. An input provided to the input device is sensed by the electronic circuitry. The circuitry provides a voltage waveform to activate the one or more piezoelectric actuators, which flexes the chassis plate and the input device to emulate the click like feed. A second exemplary embodiment positions the piezoelectric actuators between the chassis plate and the input device.

### BRIEF DESCRIPTION OF THE DRAWINGS

The present invention will hereinafter be described in conjunction with the following drawing figures, wherein like numerals denote like elements, and

FIG. 1 is an exploded view of a cellular telephone in accordance with an exemplary embodiment;

FIG. 2 is a partial cross section taken along line 2-2 of FIG. 1, without power applied to piezoelectric actuators contained within;

FIG. 3 is a partial cross section taken along line 2-2 of FIG. 1 with power applied to the piezoelectric actuators;

FIG. 4 is a partial cross section of a second exemplary embodiment without power applied to piezoelectric actuators contained within;

FIG. 5 is a partial cross section of the second exemplary embodiment with power applied to piezoelectric actuators;

FIG. 6 is a graph illustrating a comparison of the acceleration of a mechanical dome switch versus a piezoelectric actuator of the exemplary embodiment; and

FIG. 7 is a block diagram of the cellular telephone shown in FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A piezoelectric ceramic element or multiple piezoelectric ceramic elements are directly bonded to the backbone structure of portable devices, for example the metal or plastic chassis of a cell phone. A chassis of a cell phone provides structural rigidity to the phone and serves as a structure plate for the attachment of most phone modules and components. The piezoelectric ceramic elements and an input device, e.g., a morphable user interface, are bonded to opposite sides of the chassis in one exemplary embodiment. Upon application of an electric field, the in-plane shrinkage or expansion of the piezoelectric elements causes localized flexing motion of the chassis and provide tactile feedback at the interface of the input device. The input device is not directly pushed or pulled by separated piezoelectric bender actuators as described in the prior art, but is part of the structure deformed (flexed) by the integrated piezoelectric ceramic elements. The motion of the input device is flexing, rather than an up/down movement by multiple piezoelectric actuators actuating at multiple points. The benefit of the approach over the prior art is that it does not require precise mechanical alignment of an actuating element with the structure that is being pushed or pulled.

In accordance with one exemplary embodiment, at least one piezoelectric actuator, e.g., a piezoelectric bender, is bonded directly to a metal plate abutting the input device for which the haptic feedback is intended. This direct placement provides flextensional bending movement of the input device, and thus provides tactile feedback including true keyclick like tactile feedback to a user. This displacement of the input device is small, only 1.0 to 30.0 micrometers. This simple electromechanical structure is low cost and has proven reliability.

Piezoelectric actuators are uniquely capable of delivering fast, e.g., 1.0 to 10.0 milliseconds, high acceleration, e.g., 1-100 g, response needed to simulate key click responses. This class of response allows for replacement of mechanical dome switches by piezoelectric actuators for ultra thin keypads (morphable user interfaces). Piezoelectric actuators are also able to provide a broadband movement (1-2000 Hz) as opposed to fixed frequency response of resonant electromagnetic vibration motors.

The piezoelectric elements shrink or expand in the lateral direction when subject to an electric field, causing a much amplified perpendicular movement in its center with the constraint from being bonded to a hard surface, such as a phone chassis. The piezoelectric elements can be driven by a wide range of waveforms to tailor mechanical output to the user. A high slew rate step function can provide the highest acceleration and click-like feedback. Alternatively, multiple sine-waves can be used to generate feedback that might characterized as a buzz. Piezoelectric actuators can also be operated in a wide frequency range, allowing broadband haptic responses. Power consumption of piezoelectric actuators is generally comparable to or less than that of DC rotary motors. The actuators' latency (the time required to ramp up to full speed) is small enough to allow users to have nearly instantaneous response in interactive applications.

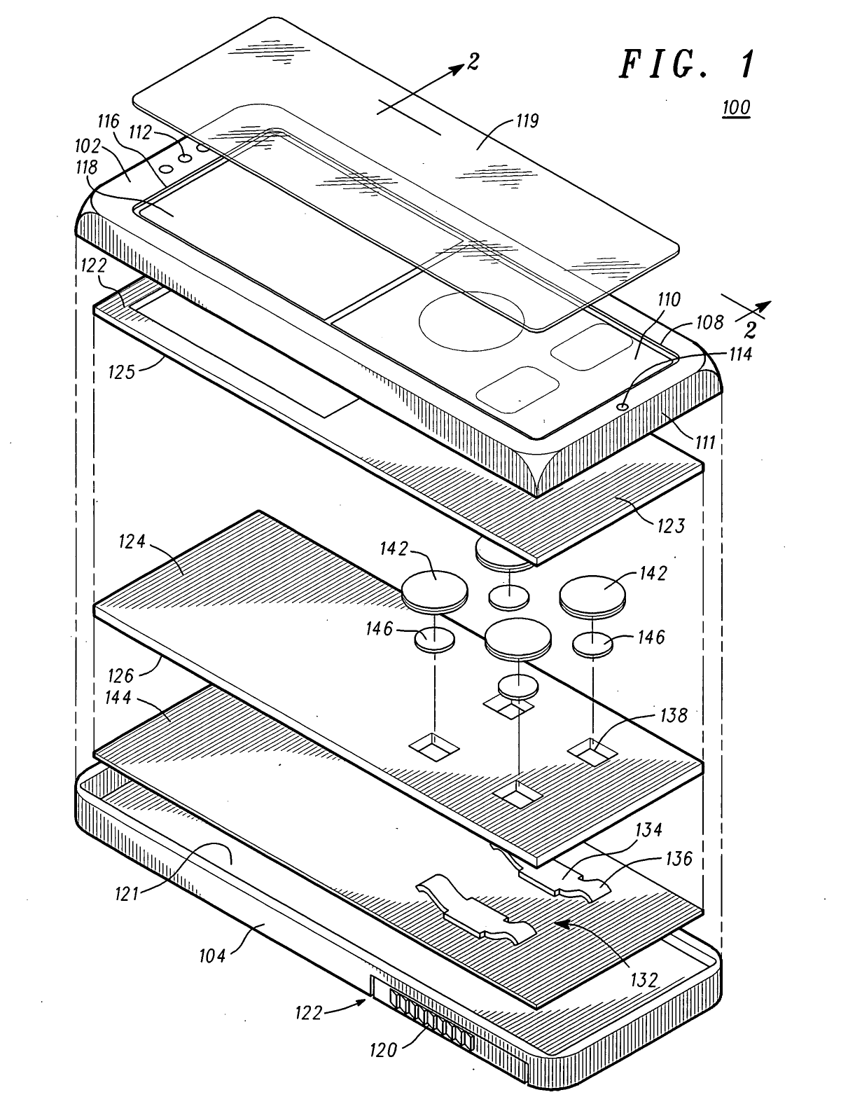

FIG. 1 is an exploded view of a cellular telephone 100 according to a first embodiment of the invention, and FIG. 2 is a partial cross section view taken along the line 2-2 of FIG. 1. The cellular telephone 100 is only one exemplary embodiment. It should be understood that any type of portable electronic device may be used with the invention described herein. The cellular telephone 100 comprises a front housing part 102, and a rear housing part 104. The front housing part 102 supports an optional antenna (not shown) and includes an opening 108 that accommodates a morphable user interface 110. A speaker grill 112 and a microphone grill 114 are also provided on the front housing part 102. A display opening 116 is also provided in the front housing part 102 that accommodates a display 118. A battery compartment cover 120 is provided for covering a battery compartment 122 in the rear housing part 104. An opening (not shown) is provided in the battery floor 121 for wiring to couple a battery (not shown) positioned in the battery compartment 122 to circuitry (not shown) on the back side 126 of the printed circuit board 124. A transparent cover 119 is positioned over the display 118 and input device 110.

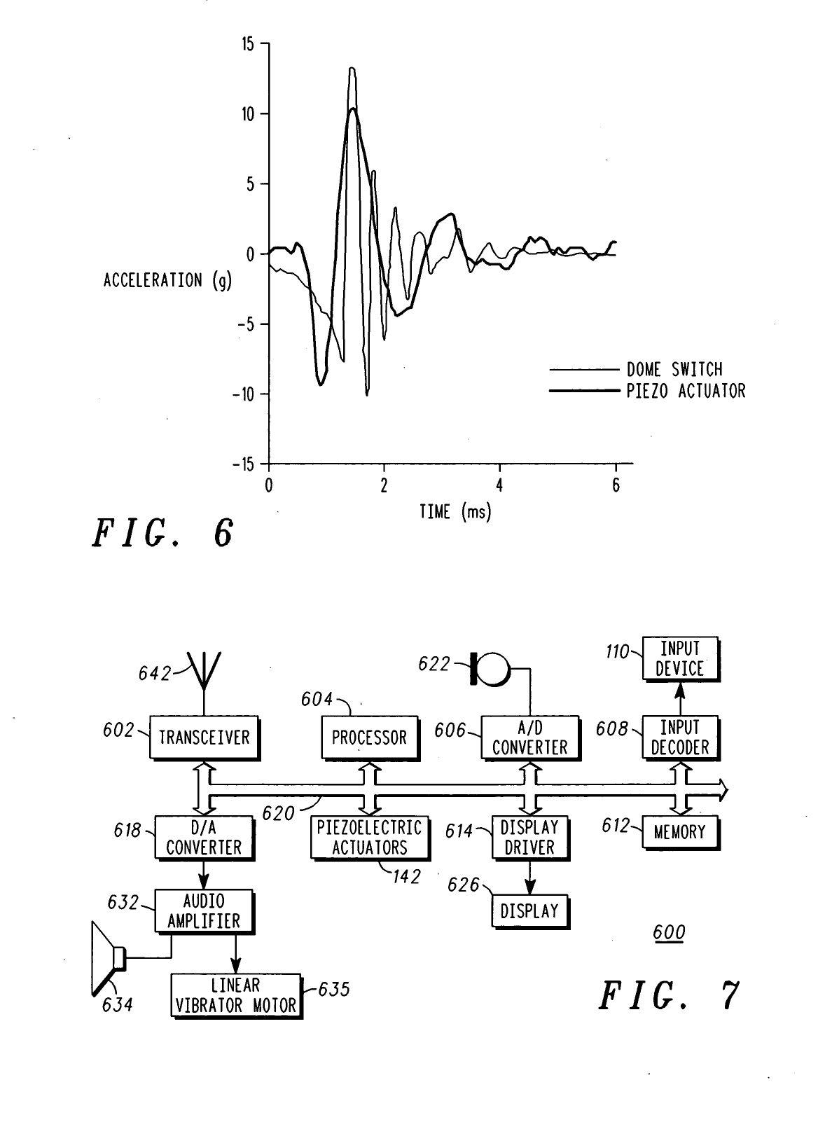

The front 102 and rear 104 housing parts enclose, among other items to be discussed, a chassis 122 secured to the front housing part 102. The chassis 122 comprises a first planar side 123 that securely positions the morphable user interface 110 within the opening 108 and the display 118 within the opening 116. The first planar side 123 of the chassis 122 is adjacent to and in contact with the planar side 111 of the input device 110. Also enclosed within the front 102 and rear 104 housing parts is a printed circuit board 124. A plurality of electrical circuit components (not shown), that make up one or more electrical circuits of the cellular telephone 100 are mounted on a back side 126 of the circuit board 124. Circuits of the cellular telephone 100 are more fully described below with reference to a functional block diagram shown in FIG. 6.

Contact devices 132 each include a base 134 secured to the circuit board 124 by a solder float (not shown), and arms 136 that extend through openings 138 in the circuit board 124 to make electrical contact with each of the piezo actuators 142. The contact devices are further coupled to circuitry (not shown) on the circuit board 124. Contact devices 132 comprise a conductive material, such as metal, and in the exemplary embodiment comprise a metal having an inherent spring action, or torque, to exert a force on the piezo actuators 142.

A layer of mylar 144 (FIG. 2) may be adhesively attached between a battery floor 121 of the rear housing part 104 and the contact devices 134. An air gap 152 exists between the printed circuit board 124 and the layer 144. The contact device 132 makes contact with the piezoelectric actuators 142, optionally through a metal contact 146, which is preferably gold. The contact device 146 may apply a spring force (as shown) against the metal contact 146 for improved conductibility. In accordance with the exemplary embodiment, the piezoelectric actuators 142 are positioned directly on a second planar side 125 of the chassis 122 that makes contact with the morphable user interface 110. The chassis 122 and morphable user interface 110 are positioned in an adjacent manner such that a flexing of the chassis 122 flexes the morphable user interface 110.

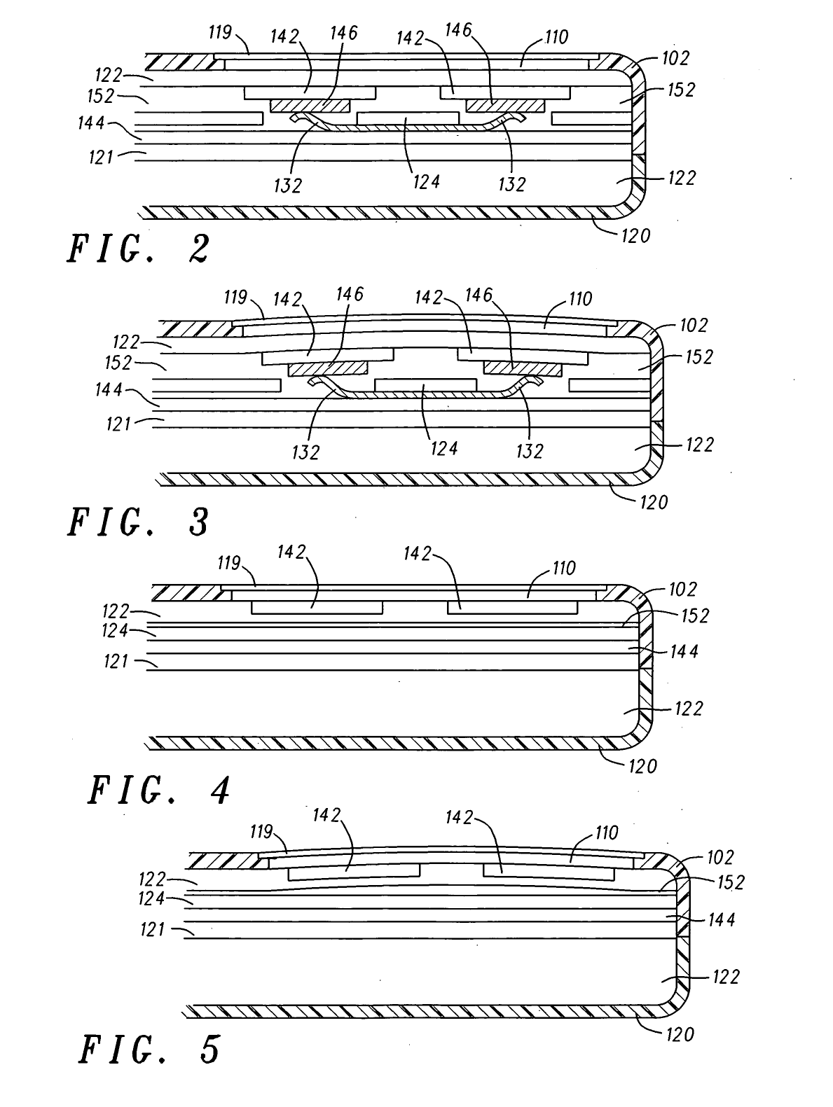

FIG. 2 shows one exemplary embodiment of how the morphable user interface 110 is secured by bonding to the front housing part 102 and the transparent cover 119 is bonded within an indent on front part 102 over the morphable user interface 110 and display 118. This example is only one way in which the morphable user interface 110 may be secured within the front housing part 102. Other examples may include, e.g., mechanical couplings. When an input, e.g., pushing on a displayed icon, is made to the morphable user interface 110, a signal is generated from, for example, a sensor (not shown) that detects movement or circuitry that detects the electronic signal generated by the input. This signal is sent to the contact devices 132 which activate the piezoelectric devices 142. The flexing movement of the piezoelectric devices 142 is transferred through the chassis 122 to the morphable user interface 110 (FIG. 3). Since the morphable user interface 110 is secured at its periphery 302, and not in the center, a flexing motion of the morphable user interface 110 results.

A second exemplary embodiment shown in FIG. 4 includes the piezoelectric actuators 142 positioned within recesses of the chassis 122 and directly against the input device 110. A conductive bonding material (not shown) is positioned between the input device and the piezoelectric actuators 142 for securing the two together and providing power to the piezoelectric actuators 142. FIG. 5 illustrates the second exemplary embodiment with power applied to the piezoelectric actuators 142 and the resulting flexing of the chassis 122, input device 110, and transparent cover 119.

FIG. 6 illustrates a comparison of the acceleration over time curve of a mechanical dome switch 502 versus the piezoelectric actuator 504 as described herein. The curves are very similar. The main character of the acceleration profile is high peak acceleration, 1-100 g, in a relatively short time period (<10 ms). The high frequency component in the acceleration curve associates with the sound accompanying the tactile click feel.

FIG. 7 is a block diagram of the cellular telephone 100 shown in FIGS. 1-3 according to the first embodiment of the invention. The cellular telephone 100 comprises a transceiver 602, a processor 604, an analog to digital converter (A/D) 606, a input decoder 608, a memory 612, a display driver 614, a digital to analog converter (D/A) 618, and piezoelectric actuators 142, all coupled together through a digital signal bus 620.

The transceiver module 602 is coupled to the antenna 106. Carrier signals that are modulated by data, e.g., digitally encoded signals for driving the MFT or digitally encoded voice audio, pass between the antenna 642, and the transceiver 602.

The input device 110 is coupled to the input decoder 608. The input decoder 608 serves to identify depressed keys, for example, and provide information identifying each depressed key to the processor 604. The display driver 614 is coupled to a display 626.

The D/A 618 is coupled through an audio amplifier 632 to a speaker 634 and a vibratory motor 635. The D/A 618 converts decoded digital audio to analog signals and drives the speaker 634 and vibratory motor 635. The audio amplifier 632 may comprise a plurality of amplifiers with each driving a separate speaker/vibratory motor combination.

The memory 612 is also used to store programs that control aspects of the operation of the cellular telephone 100. The memory 612 is a form of computer readable medium.

The transceiver 602, the processor 604, the A/D 606, the input decoder 608, the memory 612, the display driver 614, the D/A 618, the audio amplifier 632, and the digital signal bus 620, are embodied in the electrical circuit components 124 and in interconnections of the circuit board 122 shown in FIG. 1.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An electronic device comprising:
a housing defining an opening;
a chassis plate having at least a portion of its periphery secured to the housing and comprising a flexible material having a first side and a second side;
at least one piezoelectric actuator secured to one of the first and the second sides and within the periphery of the chassis plate;
an input device extending through the opening and comprising a flexible material positioned adjacent to and in contact with at least one of the first side of the chassis and the at least one piezoelectric actuator; and
electronic circuitry positioned within the housing for driving the piezoelectric actuator.

2. The electronic device of claim 1 wherein each of the at least one piezoelectric actuators comprises a piezoelectric ceramic element.

3. The electronic device of claim 1 wherein the at least one piezoelectric actuator comprises one or more piezoelectric benders.

4. The electronic device of claim 1 wherein the at least one piezoelectric actuator are bonded to pre-formed recesses in the chassis

5. The electronic device of claim 1 wherein the input device comprises a morphable user interface.

6. The electronic device of claim 1 wherein the at least one piezoelectric ceramic element may flex the input device and the chassis plate at a period of between 1.0 and 10.0 milliseconds.

7. The electronic device of claim 2 wherein the ceramic element flexes the input device and the chassis plate at an acceleration level of between 1 to 100 g.

8. The electronic device of claim 1 wherein the electronic circuitry drives the at least one piezoelectric actuator at 1-2000 HZ.

9. The electronic device of claim 1 wherein the electronic circuitry drives the at least one piezoelectric actuator with a wave to provide a keyclick like tactile feedback.

10. A cell phone comprising:
a housing defining an opening;
a flexible chassis plate positioned within the housing and having first and second sides;
at least one piezoelectric ceramic element bonded to the first side of the chassis plate;
a flexible input device bonded to the second side of the chassis and extending through the opening;
a sensing unit coupled to the input device; and
circuitry providing wave forms to the at least one piezoelectric ceramic element in response to the sensing unit.

11. The electronic device of claim 10 wherein the input device comprises a morphable user interface.

12. The electronic device of claim 10 wherein the flexible material of both the input device and the chassis are flexed by between 1.0 to 30.0 micrometers.

13. The electronic device of claim 10 wherein the electronic circuitry drives the at least one piezoelectric actuator at 1-2000 HZ.

14. The electronic device of claim 10 wherein the electronic circuitry drives the at least one piezoelectric actuator with a wave to provide a keyclick like tactile feedback.

15. A method of providing haptic feed back in an electronic device having a chassis plate comprising a flexible material having a first side and a second side, at least one piezoelectric actuator secured to one of the first and second sides, a morphable input device comprising a flexible material and having a side positioned adjacent to and in contact with at least one of the first planer side of the chassis and the at least one piezoelectric actuator, and circuitry for driving the at least one piezoelectric actuator, comprising:
providing an input to the morphable input device;
sensing the input by the circuitry;
providing a voltage waveform from the circuitry to activate the at least one piezoelectric actuator; and
flexing the chassis plate and the morphable input device in response to the at least one piezoelectric actuator being activated.

16. The electronic device of claim 15 wherein the flexing step comprises flexing the morphable input device and the chassis between 1.0 to 30.0 micrometers.

17. The electronic device of claim 15 wherein the flexing step comprises flexing the morphable input device and the chassis at a period of between 1.0 and 10.0 milliseconds.

18. The electronic device of claim 15 wherein the flexing step comprises the at least one piezoelectric ceramic element flexing the input device and the chassis plate at a force of between 1 to 100 g.

19. The electronic device of claim 15 wherein the providing a voltage waveform comprises providing a waveform having a frequency in the range of 1-2000 HZ.

20. The electronic device of claim 15 wherein the providing a voltage waveform drives the piezoelectric actuator with a wave to provide a keyclick like tactile feedback.
